(19) United States
(12) Patent Application Publication
(10) Pub. No.: US 2006/0010704 A1
(43) Pub. Date: Jan. 19, 2006

(54) Electrician's center point device to simplify conduit entry hole in electrical enclosure

(76) Inventor: Brent Charles Galbreth, Murrieta, CA (US)

Correspondence Address: Brent Galbreth, 24323 Jackson AVE #1111, Murrieta, CA, 92562, US

(21) Appl. No.: 11/181,567

(22) Filed: Jul. 14, 2005

Related U.S. Application Data
(60) Provisional application No. 60/589,130, filed on Jul. 19, 2004.

(51) Int. Cl. B25H 7/00

(52) U.S. Cl. 33/670

(57) ABSTRACT

An electrician's center point device to simplify placing conduit holes in electrical enclosures wherein a device is provided having a stamp to imprint the center point of the conduit to the electrical enclosure. Diametric lines are drawn through the center point to facilitate the positioning of a conventional knockout set on the sidewall of the electrical enclosure for pulling a hole for a conduit there through.

### U.S. PATENT DOCUMENTS

U.S. Pat. No. 4,584,780 Apr. 1986 Pressey.

U.S. Pat. No. 4,793,069 Dec. 1988 McDowell.

U.S. Pat. No. 5,383,281 Jan. 1995 Monger 33/520

U.S. Pat. No. 5,577,328 Nov. 1996 Kerry, Sr. 33/563

### FOREIGN PATENT DOCUMENTS

0819020 Jul. 1969 Canada 33/520

### BACKGROUND OF THE INVENTION

Heretofore, when placing a conduit hole in a wall of an electrical enclosure for the installation of electrical conduit, it was necessary for the electrician to determine the diameter of the conduit and mark the exact center of the conduit on the enclosure sidewall. Measuring the conduit(s) and transferring it to the enclosure wall with a rule and a straight edge usually did this. The hole is formed by a conventional knockout set, which includes a circular die and cylindrical anvil interconnected by a threaded bolt. A hole is drilled through the enclosure wall at the point marked as center of conduit. The die is placed on the outside of the enclosure against the wall; the cylindrical anvil is placed on the opposite side of the enclosure wall and the bolt extends through the anvil, the drilled hole in the enclosure wall and into the die. By tightening the bolt, the die is drawn through the enclosure wall and into the cylindrical anvil to thereby form a conduit opening in the enclosure wall, which should be positioned correctly for the installation of the electrical conduit if the center was laid-out correctly on the enclosure wall. Through experience, this method of determining the exact center of a conduit has been found to be time consuming and inexact.

It is well known that in order for electrician's to properly install such conduit they must frequently drill holes, commonly referred to as “entry” holes for receipt of the electrical conduit, such as for entry of the conduit and wire therein into a panel forming one end of a wiring enclosure, or through some other surface such as a wall or floor. Because the conduits are referred to in the trade by inside diameter, which may include fractions of an inch, and because the holes which receives a given conduit must be large enough to accommodate the added dimension of the conduits wall; accurate and neat formation of the proper size(s) and number of conduit entry can become complex and extremely time consuming. This is particularly the case if a large number and variety of sizes of conduits are required.

### SUMMARY OF THE INVENTION

After considerable research and experimentation, the center point device of the present invention has been devised which comprises of a cap and a stamp with a center point, diametric lines through center point, corresponding conduit size and an ink-well for imprinting the pattern on the stamp to the enclosure. The device's female threaded cap is designed to be coupled to the male threads of an electrical conduit for securely maintaining center point. Because, the device is placed on the threads of an electrical conduit(s) and always maintains center point, an electrician can simply place the enclosure on the device, the stamp will imprint center point, diametric lines, and conduit size. Device has now accurately imprinted pattern on enclosure wall to reduce man-hours and material waste. Diametric lines are extended beyond outer diameter of conduit to accurately line up score lines of conventional knockout set to pull entry hole through enclosure wall.

### BRIEF DESCRIPTION OF THE DRAWINGS

FIG. 1 is a perspective view of the device, illustrating the rubber stamp being placed on the cap;

FIG. 2 is a perspective view of the device being placed on the conduit;

FIG. 3 is a perspective view of the device placed on the conduit;

FIG. 4 is a perspective view showing the device on an electrical conduit, illustrating transferring ink from the ink pad to the rubber stamp;

FIG. 5 is a perspective view of the device, illustrating the electrical enclosure being placed on the device's;

FIG. 6 is a perspective view showing the imprint of diametric lines, a center point, and corresponding conduit size onto the side wall of the electrical enclosure;

FIG. 7 is a fragmentary, exploded view showing the imprint of FIG. 4 having the center hole of the center point enlarged for receiving the threaded bolt of the knockout die assembly;

FIG. 8 is a fragmentary, perspective view showing the knockout mounted on the enclosure wall with the score lines on the cylindrical anvil aligned with the diametrical lines of the imprint.

### DESCRIPTION OF THE PREFERRED EMBODIMENTS

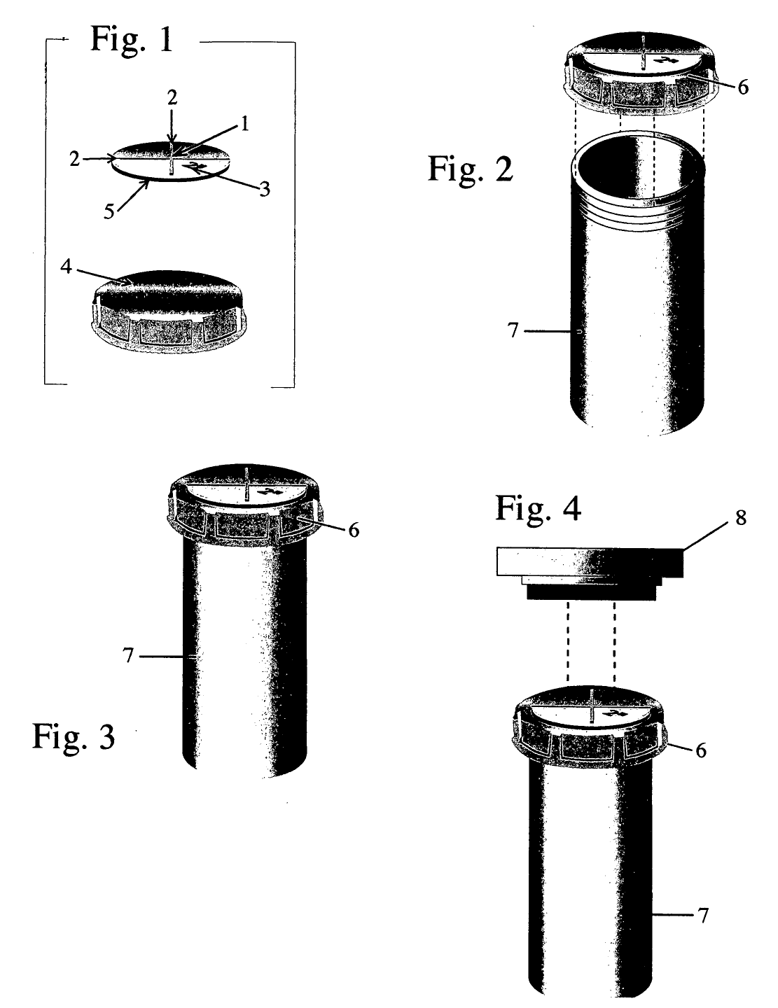

Referring to the drawings and more particularly to FIG. 1, the device 6 of the present invention is employed to facilitate placing a hole in the side wall of an electrical enclosure 9, whereby an electrical conduit 7 can be coupled to the enclosure by a threaded collar. The device 6 comprises a threaded cap 4 having a stamp 5 with two diametric lines 2, a center point 1, corresponding conduit size 3.

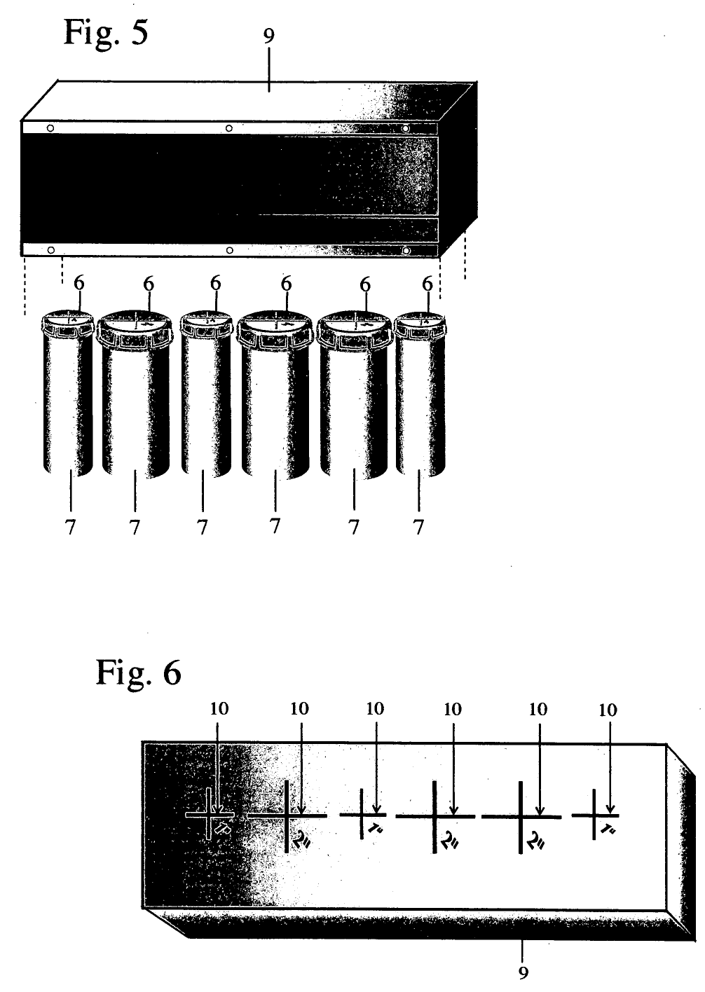

In use as shown in FIG. 5, the device 6 is threaded on an electrical conduit(s) 7, the rubber stamp 5 is inked 8, the enclosure side wall 9 is placed on the device(s) 6 to which it is desired to connect an electrical conduit(s) 7, and the diametric lines 2, center point 1, and corresponding conduit size 3 are imprinted 10 on the side wall 9 as shown in FIG. 6.

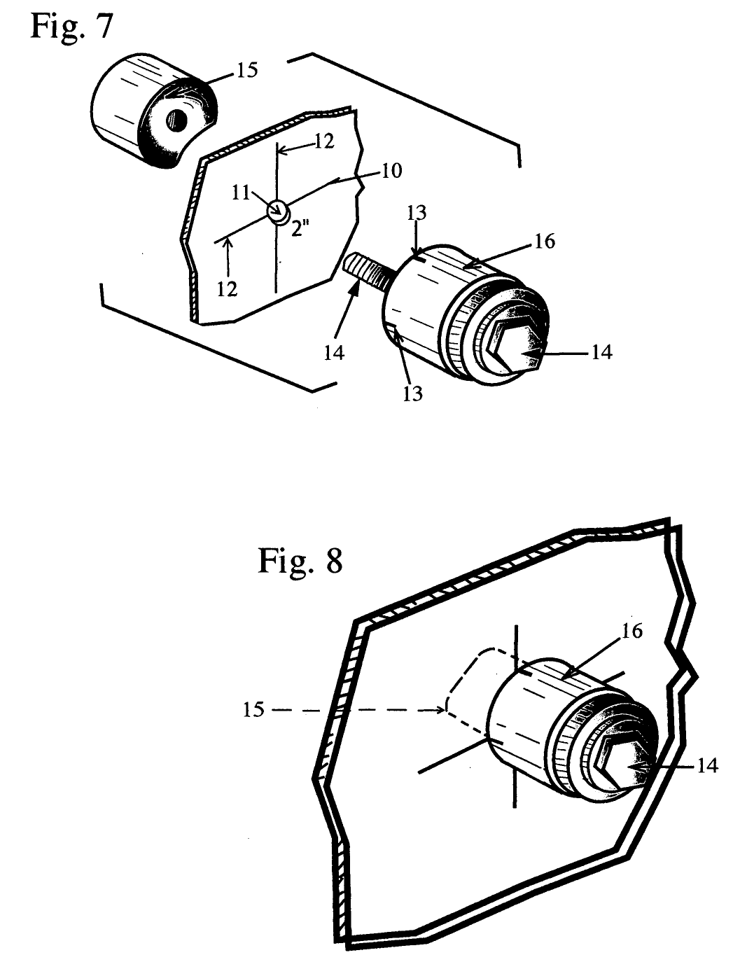

As will be seen in FIG. 7, a hole is placed through the center of the imprint 10 and a conventional knock out set, including a circular die 15, a cylindrical anvil 16, and a connecting bolt 14, is mounted on the electrical enclosure wall 9 as shown in FIG. 8. The circular die 15 is placed on one side of the wall, and the cylindrical anvil 16 is placed on the opposite side of the wall 9, the bolt 14 extends through the central hole 11 and is threaded into the circular die 15. The cylindrical anvil 16 has four score lines 13 spaced 90 degrees apart which are manually aligned with the extended diametric lines 12, the bolt 14 is then tightened to draw the circular die 15 into the cylindrical anvil 16, whereby an opening is formed in the side wall 9 which is positioned correctly for the installation of an electrical conduit.

From the above description, it will be readily appreciated by those skilled in the art that the device of the present invention provides an improved tool for use by electricians for quickly and accurately pulling holes in side walls of electrical enclosures for installation of electrical conduits.

It is contemplated that plurality of devices of various sizes will be packaged as a kit so that the electrician will choose a device having a certain diameter corresponding to the size of the electrical conduit being installed.

While the device can be fabricated from various materials, the device of the present invention is made from injection molding with multiple cavities to provide plurality of devices and the stamp is made from vulcanized rubber with a quarter inch thick foam for an accurate imprint.

It is to be understood that the forms of the invention herewith shown and described are to be taken as preferred examples of the same, and that various changes in the shape, size and arrangement of parts may be resorted to, without departing from the spirit of the invention or scope of the subjoined claims.

I claim:

1. An electrician's center point device to simplify placing holes in an electrical enclosures comprising of a center point device having a stamp to impress a pattern on the wall of an electrical enclosure. Whereby the device's cap is threaded onto the conduit, the stamp remains above the conduit and the center point, diametric lines, and conduits trade size is imprinted from the stamp to the sidewall of the electrical enclosure. To thereby locate the center point and diametric lines to accurately position conventional knockout set for pulling a hole through the electrical enclosure side wall, without any measuring.

2. A method of accurately placing electrical conduit holes in the side wall of an electrical enclosure to facilitate the installation of electrical conduits therein comprising the steps of:
a) threading the device on an electrical conduit;
b) leveling the device up or down to match other conduits that have been installed in a raceway, by simply tightening or loosening the device;
c) inking the stamps center point, diametric lines, and conduit size on the device;
d) placing the side wall of electrical enclosure on the stamp to accurately imprint center point, diametric lines, and conduit size;
e) extending the diametric lines with a straight edge beyond the outside diameter of conduit to be installed, for accurate alignment of score lines on conventional knockout.
f) drilling a hole through the side wall of electrical enclosure at the center point of the imprint

3. A method of accurately placing electrical conduit holes in a side wall of an electrical enclosure according to claim 2 wherein the diametric lines are extended outwardly beyond the outside diameter of the conduit to be installed:
g) placing a circular die on one side of the electrical enclosure sidewall;
h) placing a cylindrical anvil on the other side of the enclosure wall and aligning score lines on the peripheral surface of the cylindrical anvil with the extended diametric lines of the imprint;
i) inserting a bolt through the cylindrical anvil, sidewall hole, and into the die;
j) aligning the peripheral surface of cylindrical anvil with the extended diametric lines of the imprint;
k) tightening the bolt to draw the circular die through the enclosure sidewall and into the cylindrical anvil.

4. A method of accurately placing electrical conduit holes in a side wall of an electrical enclosure according to claim 2, wherein a plurality of center point devices of various sizes are provided; each having female threads to match the corresponding male threads of an electrical conduit to be installed on the wall of the electrical enclosure. Wherein the device will thread securely to the male threads of the conduit to retain center point of conduit for imprint on the electrical enclosure.

5. The device of claim 1, is formed of plastic.

6. The device of claim 1, is formed of resin.

7. The device of claim 1, is formed of injection molded plastic.

8. Marking the center point, diametric lines, and corresponding conduit size without performing any mathematical calculations.

9. The stamp of claim 1, is formed of vulcanized rubber.
